(19) United States
(12) Patent Application Publication
(10) Pub. No.: US 2016/0000138 A1
(43) Pub. Date: Jan. 7, 2016

(54) FOOD PROCESSING MACHINE

(71) Applicant: TS TECHNIEK BV, Pijnacker (NL)

(72) Inventors: Ivar van Leeuwen, Waddinxveen (NL); Dennis van Zweden, Zoetermeer (NL)

(21) Appl. No.: 14/768,299

(22) PCT Filed: Mar. 14, 2014
(86) PCT No.: PCT/EP2014/000692

§ 371 Date: Aug. 17, 2015

(30) Foreign Application Priority Data
Mar. 15, 2013 (EP) 13001334.5

(51) Int. Cl. A23P 1/08

(52) U.S. Cl. CPC A23P 1/084

(57) ABSTRACT

The invention relates to a food processing machine for processing food products, particularly seafood or vegetables for producing tempura, comprising: a dipping bath (7) containing a liquid or semi-liquid food material, particularly a batter; and a conveyor arrangement (6) for conveying said food products through said dipping bath (7), so that said food products are coated with said food material in said dipping bath (7). The invention is characterized in that said conveyor arrangement (6) comprises a round belt conveyor (27, 28) instead of a conventional wire belt conveyor. Further, the invention relates to a corresponding method of operation.

### FIELD OF THE INVENTION

The invention relates to a food processing machine for processing food products, particularly seafood or vegetables for producing tempura.

### BACKGROUND OF THE INVENTION

Food processing machines for producing tempura are disclosed, for example, in EP 1 106 067 A1, U.S. 2003/0000394 A1 and WO 2006/103244 A1. The conventional food processing machines for producing tempura comprise a dipping bath containing a semi-liquid batter and a conveyor arrangement for conveying the food products (e.g. seafood or vegetables) through the dipping bath, so that the food products are coated with the batter in the dipping bath. The conveyor arrangement typically comprises wire belt conveyors for dipping the food products into the dipping bath. One advantage of wire belt conveyors as used in the conventional food processing machines is that they are permeable to the coating substance (e.g. batter). Another advantage of wire belt conveyors is that they are easy to clean.

However, the conventional food processing machines for producing tempura do not yield an entirely satisfactory coating result.

Further, the technological background of the invention comprises U.S. 2002/020343 A1, U.S. 2004/083901 A1, U.S. Pat. No. 6,315,100 B1 and U.S. 2005/169099 A1.

### SUMMARY OF THE INVENTION

It is therefore an object of the invention to provide an improved food processing machine for producing tempura. Further, it is an object of the invention to provide an improved method of operation of such a food processing machine.

These objects are achieved by the food processing machine and the method of operation according to the independent claims.

The inventors have recognized that the coating result is affected by the friction between the tempura and the conveyor belt on the one hand and the friction between the food product (e.g. seafood, vegetables) and the conveyor belt on the other hand. Further, the inventors have recognized that conventional wire belt conveyors are not entirely satisfactory since they provide too much friction between the tempura and the wire belt. Therefore, the food processing machine according to the invention comprises a round belt conveyor for dipping the food products (e.g. seafood or vegetables) into the dipping bath. These round belt conveyors have less grip on the tempura while the product has still enough grip on the conveyor. The round belt conveyor preferably comprises several parallel round strings each having a round cross-section, wherein the cross-section is preferably circular. Further, the round belt is preferably made of plastics. However, it should be noted that the round belt conveyor according to the invention is also permeable to the coating substance (e.g. batter) which is essential in order to achieve a satisfactory coating result.

Further, it should be noted that the food processing machine according to the invention can also be used for processing other food products than seafood or vegetables. For example, is also possible to process poultry, beef or meat.

In a preferred embodiment of the invention, the conveyor arrangement comprises an input conveyor, a first transfer conveyor, a dipping conveyor, a second transfer conveyor and finally an output conveyor, which are arranged one behind another.

The input conveyor receives the uncoated food products from another machine or via a conveyor line. The input conveyor preferably comprises an adjustable inclination.

The first transfer conveyor receives the uncoated food products from the input conveyor and transfers the uncoated food products to the dipping conveyor.

The dipping conveyor receives the uncoated food products from the first transfer conveyor and conveys the food products through the dipping bath so that the food products are coated within the dipping bath. Further, the dipping conveyor also removes the coated food products from the dipping bath.

The second transfer conveyor receives the coated food products from the dipping conveyor and transfers them to the output conveyor.

Finally, the output conveyor receives the food products from the second transfer conveyor and discharges the coated food products. In this connection, it should be noted that the output conveyor preferably comprises an adjustable inclination.

The dipping conveyor preferably comprises a round belt conveyor, while the other conveyors preferable comprise conventional wire belt conveyors.

Further, the output conveyor preferably comprises an adjustable output end which can be adjusted between a sharp nose configuration and a butt nose configuration. To allow such an adjustable output configuration of the output conveyor, the output conveyor preferably comprises an upper roller and a lower roller at the output end of the output conveyor, wherein the lower roller can be shifted in the conveying direction in order to adjust either the butt nose position or the sharp nose position of the output end of the output conveyor. If a sharp nose configuration of the output end is desired, the lower roller is pushed forward ahead of the upper roller. However, if a butt nose configuration of the output end is desired, the lower roller is retracted behind the upper roller.

In the preferred embodiment of the invention, the dipping conveyor comprises an upper conveyor and a lower conveyor, wherein the upper conveyor is preferably moveable between a lowered operating position and a raised maintenance position allowing access to the lower conveyor. The upper conveyor and the lower conveyor together form a product channel in between wherein the distance between the upper conveyor and the lower conveyor defines the height of the product channel. The product channel runs through the dipping bath so that the complete cross-section of the product channel is completely under the filling level in the dipping bath at least at one point of the product channel. In other words, the product channel goes down so deep into the dipping bath that the food products entirely submerge into the batter.

Further, it should be noted that the product channel preferably has an adjustable height which can be adapted to the size of the food products. The adjustment of the height of the product channel is preferably performed by adjusting the vertical position of the upper conveyor relative to the vertical position of the lower conveyor.

The food processing machine according to the invention preferably comprises a cooling apparatus for cooling the upper belt and/or the lower belt of the dipping conveyor. In the preferred embodiment of the invention, the cooling apparatus comprises an upper cooling labyrinth for cooling the upper conveyer hanging in the dipping bath and a lower cooling labyrinth for cooling the lower conveyor, wherein the lower cooling labyrinth is preferably arranged under the dipping bath.

It should further be noted that the dipping bath must be refilled with the liquid or semi-liquid food material (e.g. batter) from time to time. In the conventional food processing machines, such a refill of the dipping bath disrupts the operation of the food processing machine.

The food processing machine according to the invention solves this problem by providing an additional buffer for buffering the liquid or semi-liquid food material, wherein the buffer comprises an inlet for receiving the liquid or semi-liquid food material (e.g. batter) from an external source (e.g. a mixer) and an outlet for discharging the liquid or semi-liquid food material into the dipping bath. The buffer can easily be refilled with the food material without disrupting the operation of the food processing machine. Further, the buffer can discharge the liquid or semi-liquid food material into the dipping bath without disruption of the operation of the food processing machine.

Further, it should be noted that tempura batter has short shelf life. Particularly, the product quality of a tempura batter is not constant. Immediately after preparation of the tempura batter, the product quality is poor. Then, the product quality of the tempura rises to a point where it is good, and then passes again. With the buffer tank, the tempura can be delivered at the perfect time. Therefore, the buffer tank is not only a buffer to provide enough tempura at the right time but also to maintain the product quality of the tempura.

In the preferred embodiment of the invention, the buffer comprises a filling level sensor for measuring a filling level of the liquid or semi-liquid food material in the buffer. It is preferred to provide two filling level sensors one of which detecting a maximum filling level while the other filling level sensor detects a minimum filling level.

Further, the buffer preferably comprises an outlet valve for controlling the flow of the liquid or semi-liquid food material from the buffer into the dipping bath.

It should further be noted that the buffer is preferably arranged above the conveyor arrangement and preferably comprises several outlet openings being arranged across the conveyor arrangement, wherein the outlet valve preferably jointly opens or closes the outlet openings of the buffer. For example, this can be achieved by a pressure cylinder (e.g. hydraulic or pneumatic) moving a piston rod which in turn controls the outlet valves of the individual outlet openings of the buffer.

Further, the buffer preferably comprises a cleaning hatch which can be opened for cleaning the interior of the buffer.

Moreover, the buffer preferably comprises a safety hatch which can be moved between an opened maintenance position and a closed operating position. The position of the safety hatch can be detected by a sensor. Further, the safety hatch can also be used to deflect the flow of the liquid or semi-liquid food material leaving the outlet openings of the buffer.

It is also preferred to provide a temperature sensor for measuring a temperature associated to the temperature of the liquid or semi-liquid food material in the dipping bath. Therefore, the temperature sensor is preferably arranged at the bottom of the dipping bath.

Further, the food processing machine according to the invention preferably comprises at least one filling level sensor for measuring the filling level of the liquid or semi-liquid food material in the dipping bath. In the preferred embodiment of the invention, there are two filling level sensors, wherein the first filling level sensor detects a maximum filling level while the other filling level sensor detects a minimum filling level.

Moreover, the dipping bath preferably comprises a drain outlet and a drain valve arranged in the drain outlet for draining the dipping bath for maintenance and cleaning purposes.

Further, the food processing machine according to the invention preferably comprises a control unit for controlling the operation of the food processing machine.

At its input side, the control unit is preferably connected to the filling level sensor of the buffer and/or to the filling level sensor of the dipping bath, while the output side of the control unit is preferably connected to the outlet valve of the buffer, so that the control unit controls the filling level of the liquid or semi-liquid food material in the dipping bath. If the filling level in the dipping bath is too low, the control unit opens the outlet valve of the buffer so that the dipping bath is refilled with food material from the buffer. However, if the filling level of the food material in the dipping bath is too high or acceptable, the control unit closes the outlet valves of the buffer so that no food material is discharged from the buffer into the dipping bath.

Further, the input side of the control unit is preferably connected to the temperature sensor of the dipping bath, while the output side of the control unit is connected to the cooling apparatus, so that the control unit controls the temperature in the dipping bath. If the temperature exceeds a certain threshold, the control unit activates the cooling apparatus in order to avoid overheating. However, if the measured temperature is too low or acceptable, the control unit reduces the cooling power of the cooling apparatus or switches the cooling apparatus off.

Further, the food processing machine according to the invention preferably comprises at least one so-called air knife to blow off excess product after the coating of the food products in the dipping bath. These air knives are known from the state of the art.

Further, it should be noted that the invention also claims protection for a method of operation of such a food processing machine.

The invention and its particular features and advantages will become more apparent from the following detailed description considered with reference to the accompanying drawings.

### BRIEF DESCRIPTION OF THE DRAWINGS

FIG. 1 is a perspective view of a preferred embodiment of a food processing machine for producing tempura.

FIG. 2 is a perspective view of the machine according to FIG. 1 from the bottom.

FIG. 3 is a partially cut-away perspective view of the food processing machine according to FIGS. 1 and 2.

FIG. 4 shows a perspective view of a buffer arrangement of the food processing machines as shown in FIGS. 1-3.

FIG. 5 shows a side view of the buffer arrangement as shown in FIG. 4 with an opened safety hatch.

FIG. 6 shows a side view of the buffer arrangement, wherein the safety hatch is closed.

FIG. 7 shows a perspective view of the output conveyor of the food processing machine in a sharp nose configuration.

FIG. 8 shows a perspective view of the output conveyor in a butt nose configuration.

FIG. 9 shows a perspective view of the pivoting mechanism of the output conveyor.

FIG. 10 shows a perspective view of the control panel and the filling level sensors of the dipping bath along with the drain outlet.

FIG. 11 shows the lower cooling labyrinth from below.

FIG. 12 shows a side view of the dipping conveyor with an upper cooling labyrinth.

FIG. 13 shows another side view of the conveyor arrangement with the dipping conveyor.

FIG. 14 shows another side view of the dipping conveyor. FIG. 15 shows a perspective view of the input conveyor.

FIG. 16 shows a perspective view of the input conveyor from below.

FIG. 17 shows tubes for providing and discharging coolant to and from the cooling labyrinth.

FIG. 18 shows a perspective view of an electrical cabinet of the food processing machine.

FIG. 19 shows a schematic block diagram of the food processing machine.

FIG. 20 shows a flow chart illustrating the method of operation of the food processing machine.

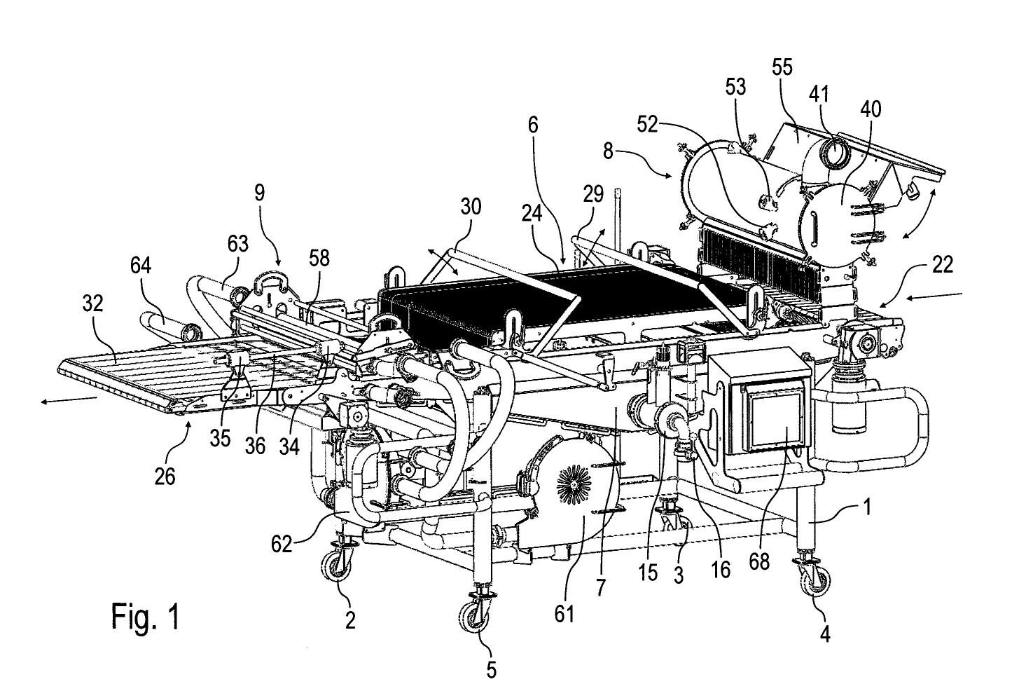

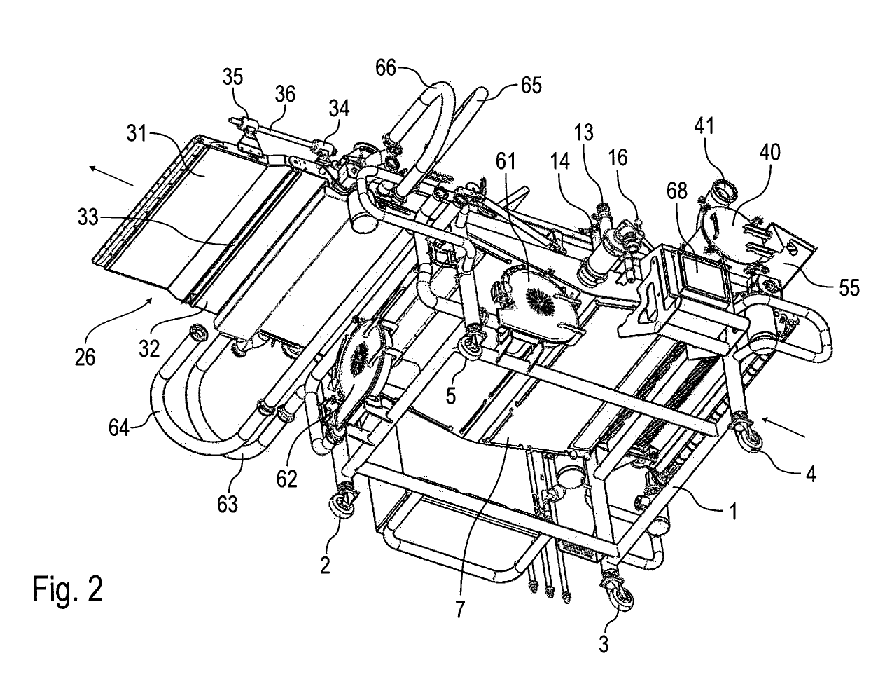

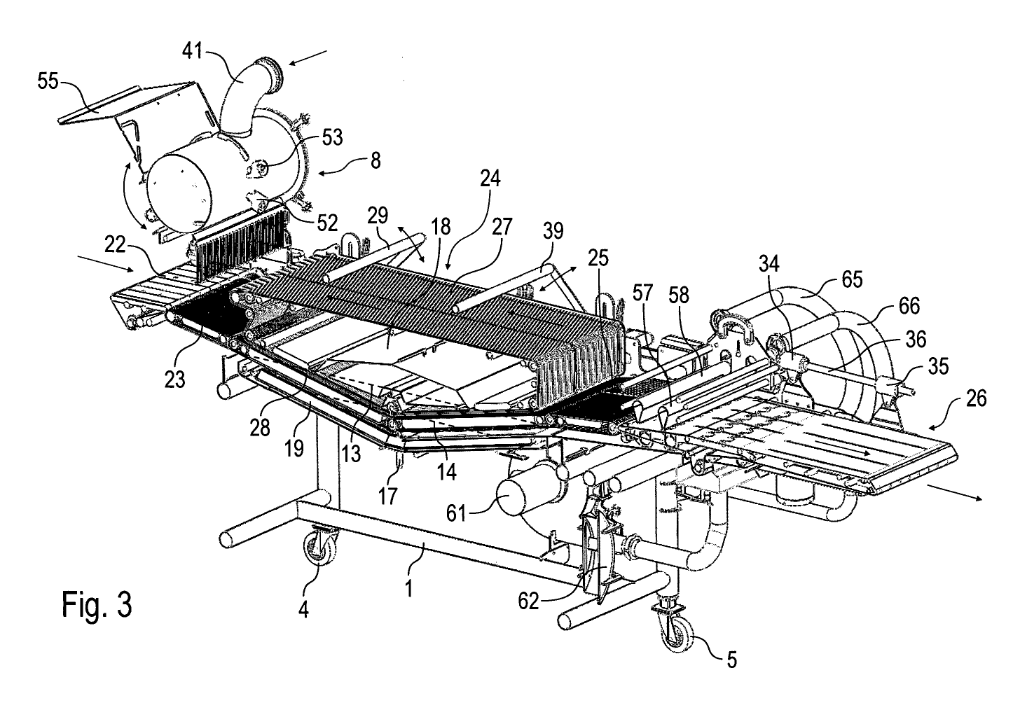

### DETAILED DESCRIPTION OF THE DRAWINGS

The drawings illustrate a preferred embodiment of a food processing machine for coating food products (e.g. seafood or vegetables) with a batter for producing tempura.

The food processing machine comprises a support frame 1 which is arranged on rolls 2-5 and which supports several sub assemblies, namely a conveyor arrangement 6, a dipping bath 7, a buffer arrangement 8, an air knife arrangement 9 and a control system 10 which will be described in the following.

### Dipping Bath

The dipping bath 7 can be filled with the batter in order to coat the food products (e.g. seafood or vegetables) in the dipping bath 7. Therefore, the filling level of the batter in the dipping bath 7 must be maintained between a maximum filling level 11 and a minimum filling level 12. Therefore, the dipping bath 7 comprises a maximum filling level sensor 13 and a minimum filling level sensor 14. The maximum filling level sensor 13 responds when the actual filling level in the dipping bath 7 exceeds the maximum filling level 11. The minimum filling level sensor 14 responds when the actual filling level in the dipping bath exceeds the predetermined minimum filling level 12. During operation of the food processing machine, the actual filling level of the batter in the dipping bath 7 is always maintained between the maximum filling level 11 and the minimum filling level 12.

Further, the dipping bath 7 comprises a drain opening 15 and a drain valve 16 which is arranged in the drain outlet 15.

The drain valve 16 can be manually actuated by a hand lever so that the drain valve 16 can be opened to drain the dipping bath 7 for maintenance or cleaning of the dipping bath 7.

Moreover, the dipping bath 7 comprises a temperature sensor 17 which is arranged at the bottom side of the dipping bath 7 and measures the temperature of the dipping bath 7. The output of the temperature sensor 17 can be used for control purposes which will be explained in more detail later.

Further, the dipping bath 7 comprises an upper cooling labyrinth 18 and a lower cooling labyrinth 19 which are connected to a coolant inlet tube 20 and a coolant outlet tube 21. The upper cooling labyrinth 18 and the lower cooling labyrinth 19 are used to cool the belts of the conveyor arrangement 6 within the dipping bath 7, which will be explained in more detail later.

### Conveyor Arrangement

The conveyor arrangement 6 comprises an input conveyor 22 for receiving the uncoated food products (e.g. seafood or vegetables). The input conveyor 22 is a wire belt conveyor so that the input conveyor 22 is easy to clean and satisfies hygienic requirements. Further, the input conveyor 22 comprises an adjustable inclination which can be adapted according to a conveyor line arranged upstream the food processing machine.

Further, the conveyor arrangement 6 comprises a transfer conveyor 23 which is arranged downstream the input conveyor 22. The transfer conveyor 23 is also realized as a wire belt conveyor.

Moreover, the conveyor arrangement 6 comprises a dipping conveyor 24 which is arranged downstream the transfer conveyor 23. The dipping conveyor 24 conveys the uncoated food products through the dipping bath 7 so that the food products are coated within the dipping bath 7. Further, the dipping conveyor 24 then removes the coated food products from the dipping bath 7. The dipping conveyor 24 comprises round belt conveyors. This is advantageous since round belt conveyors have less grip on the tempura batter while the food products still have enough grip on the round belts. Therefore, the use of a round belt conveyor instead of a conventional wire belt conveyor yields a better coating result.

Another transfer conveyor 25 is arranged downstream the dipping conveyor 24, wherein the transfer conveyor 25 is also realized as a wire belt conveyor.

At the downstream end of the conveyor arrangement 6, an output conveyor 26 is arranged, which is also realized as a wire belt conveyor.

The dipping conveyor 24 actually comprises an upper dipping conveyor 27 and a lower dipping conveyor 28 which are arranged above each other and together form a product channel which runs through the dipping bath 7. The product channel between the upper dipping conveyor 27 and the lower dipping conveyor 28 comprises an adjustable height h which can be adapted to the size of the food products to be coated. The height h of the product channel can be adjusted by two adjustment levers 29, 30 which can be swivelled manually in order to adjust the height h of the product channel. Further, it should be noted that the upper dipping conveyor 27 can be swivelled upwards to provide access to the lower dipping conveyor 28 for maintenance or cleaning purposes.

The output conveyor 26 comprises an adjustable inclination which can be adapted to a conveyor line downstream the food processing machine. Therefore, the output conveyor 26 comprises an upstream section 31 and a downstream section 32, wherein the downstream section 32 of the output conveyor 26 can be swivelled relative to the upstream section 31 of the output conveyor 26 around a swivel axis 33.

Further, the output conveyor 26 comprises an adjustment mechanism for adjusting the inclination of the downstream section 32 relative to the upstream section 31. The adjustment mechanism comprises a guidance 34 mounted to the upstream section 32 and a guidance 35 mounted to the downstream section 32. A guiding rod 36 is slidable within the guidances 34, 35, wherein the guiding rod 36 can be fixed within the guidances 34, 35 at the desired position in order to adjust the inclination angle of the downstream section 32 of the output conveyor 26 relative to the upstream section 31 of the output conveyor 26.

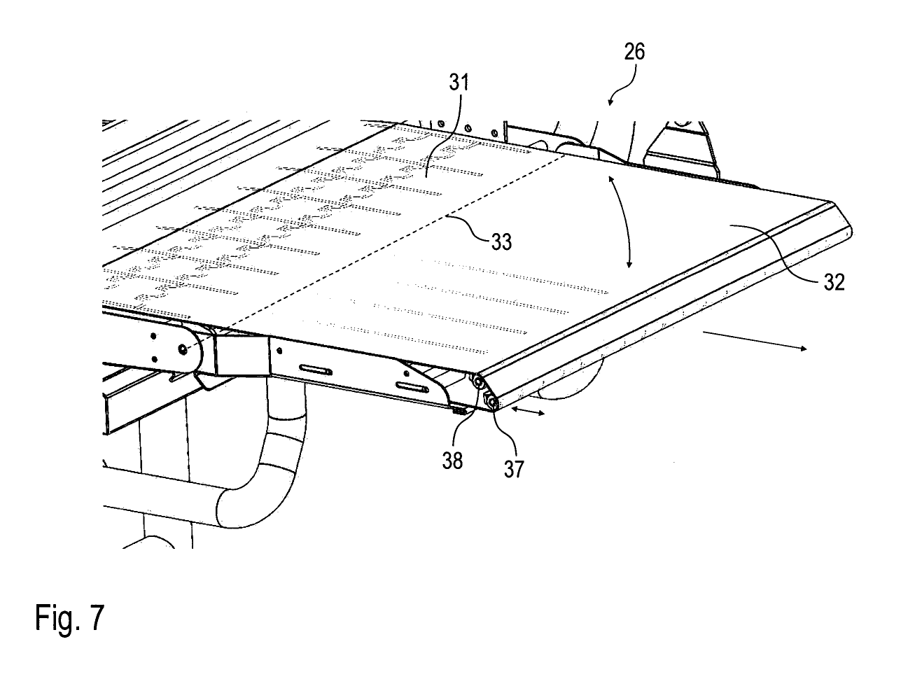

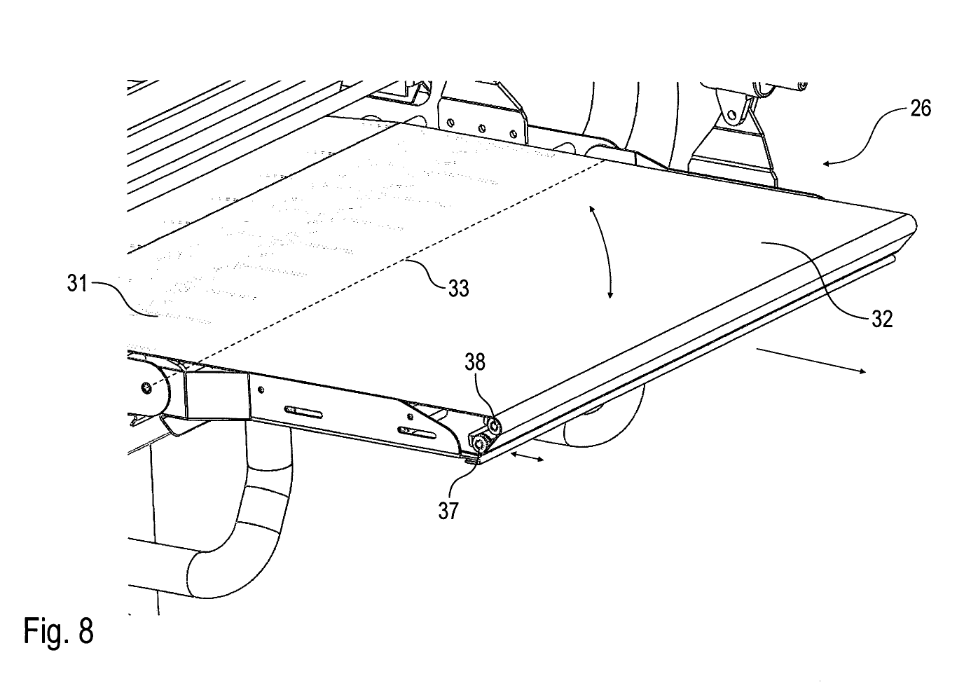

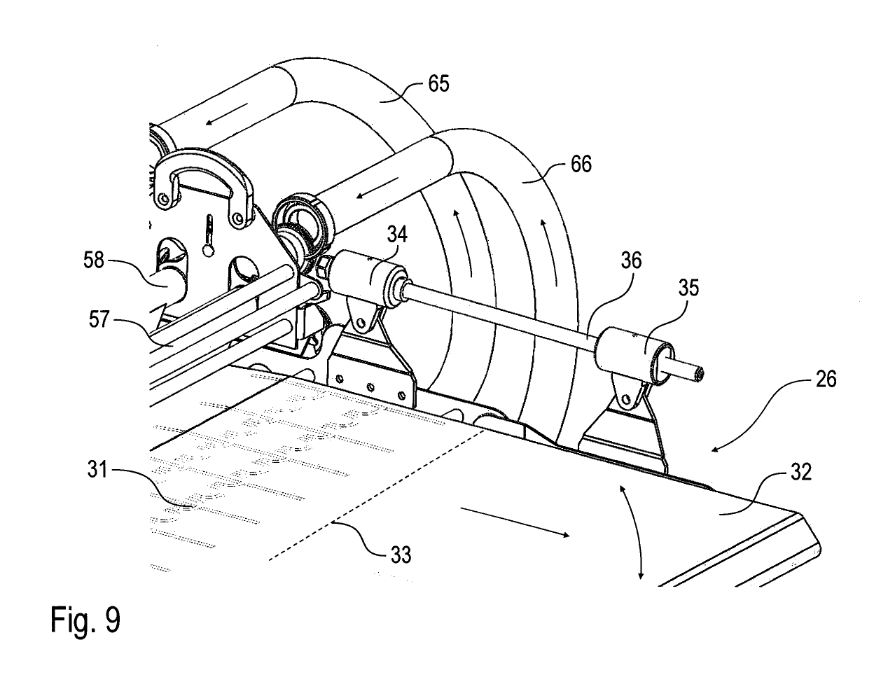

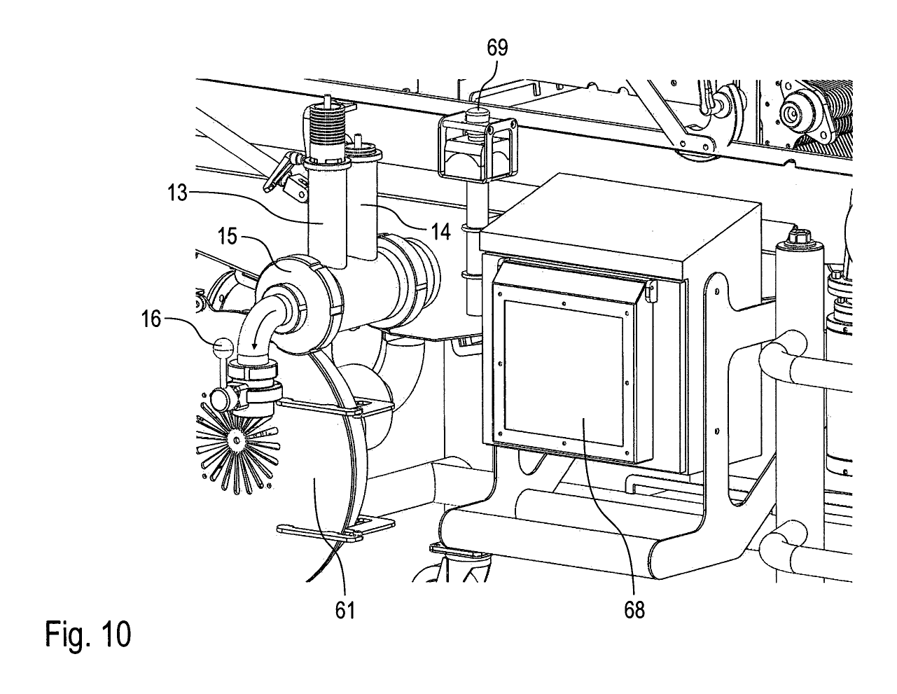

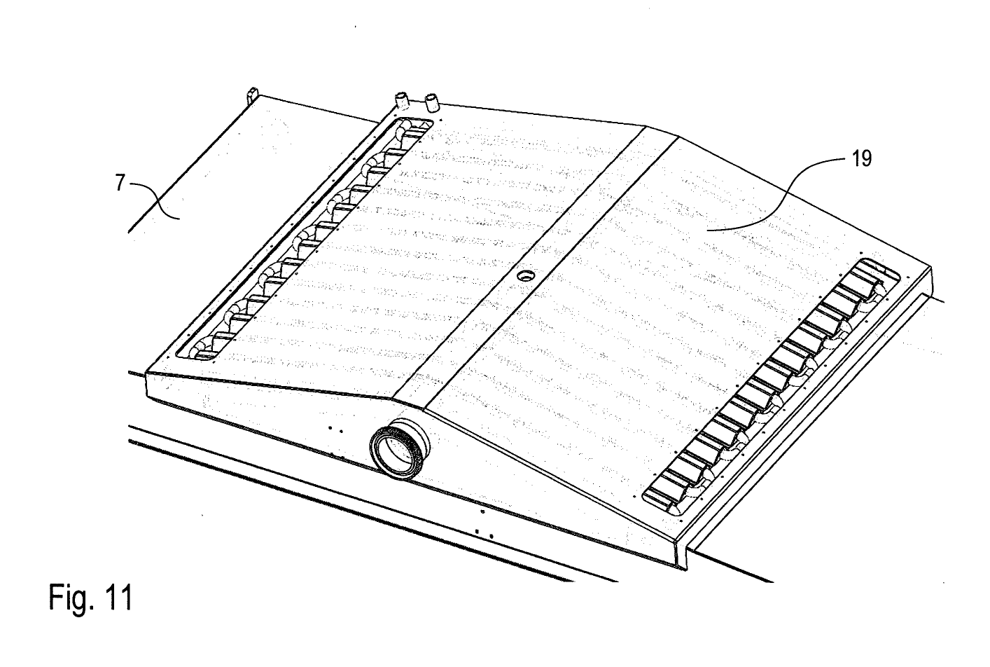

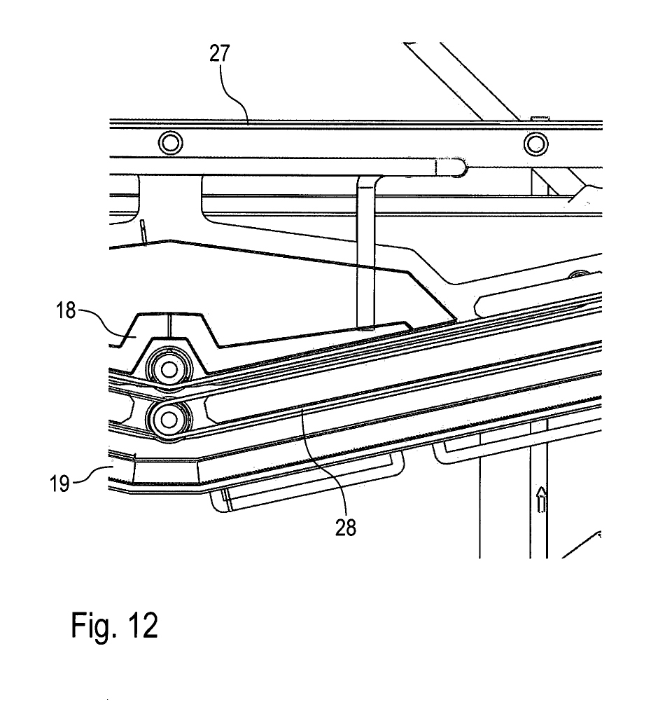

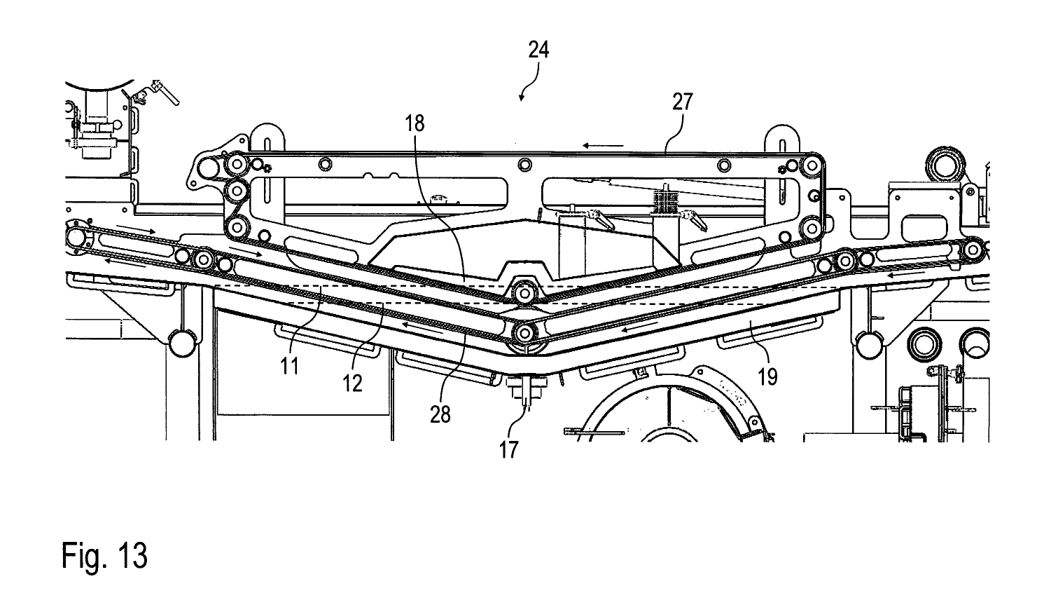

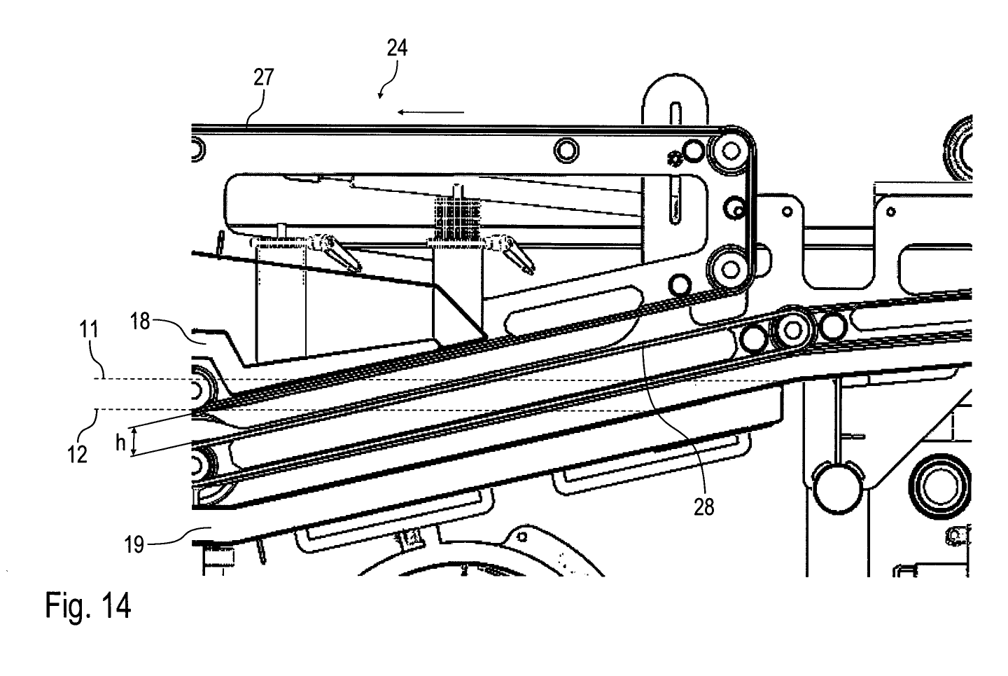

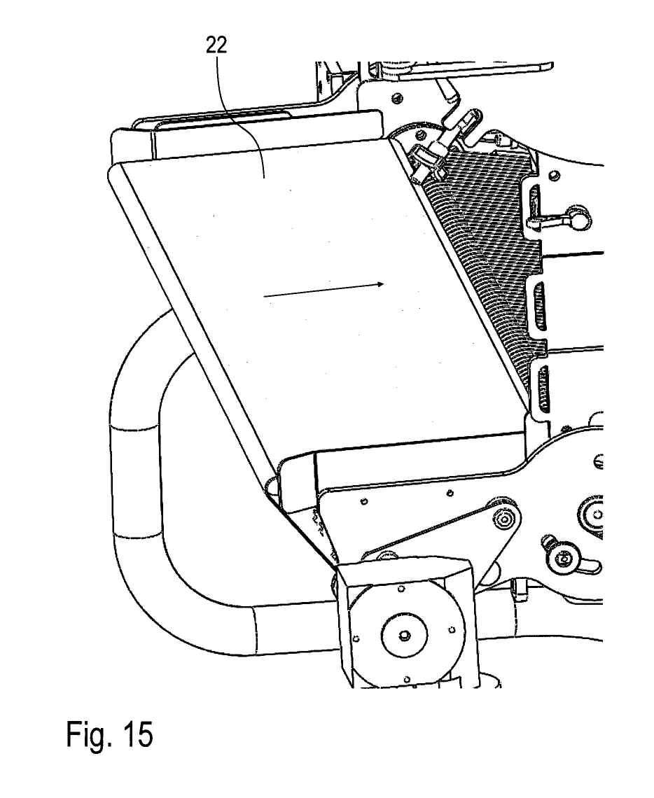

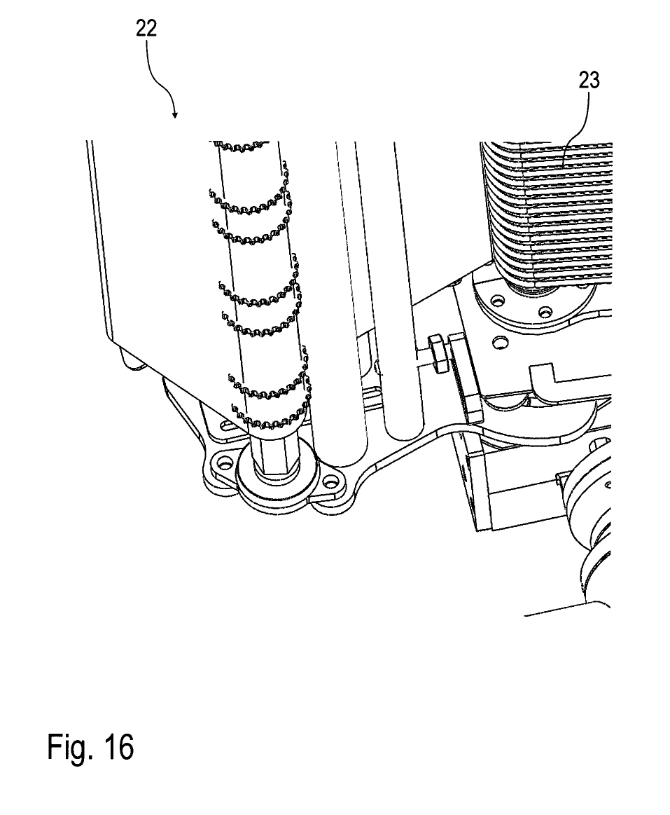

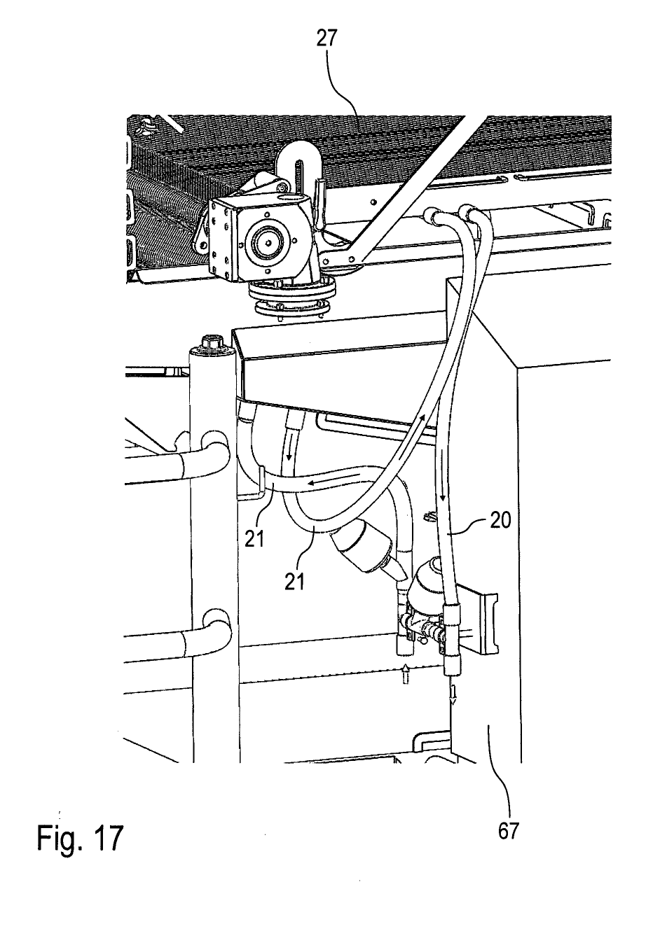

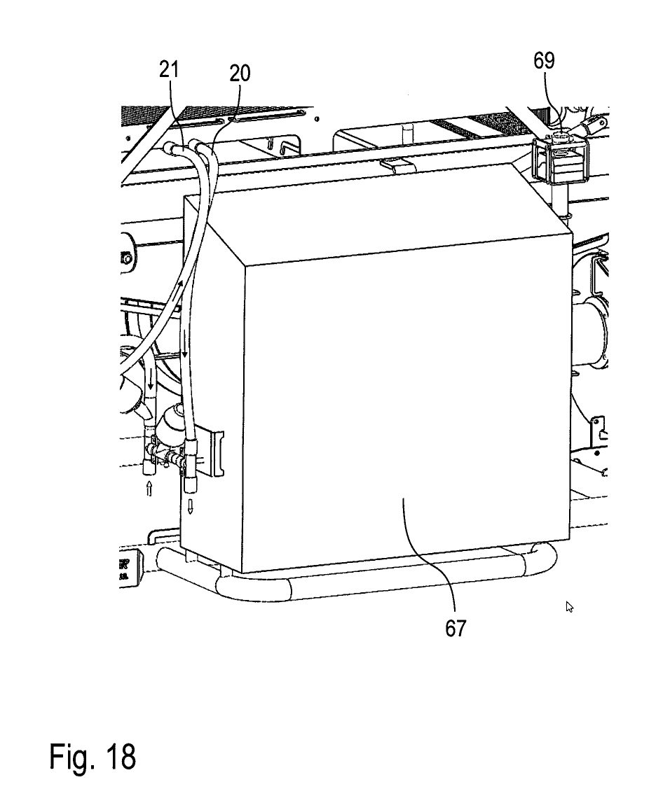

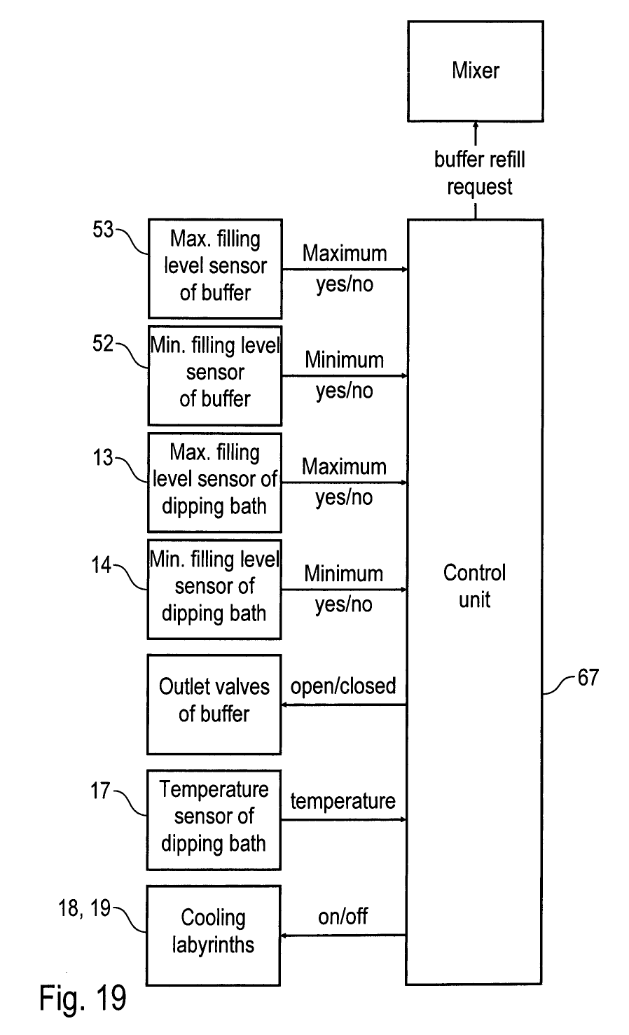

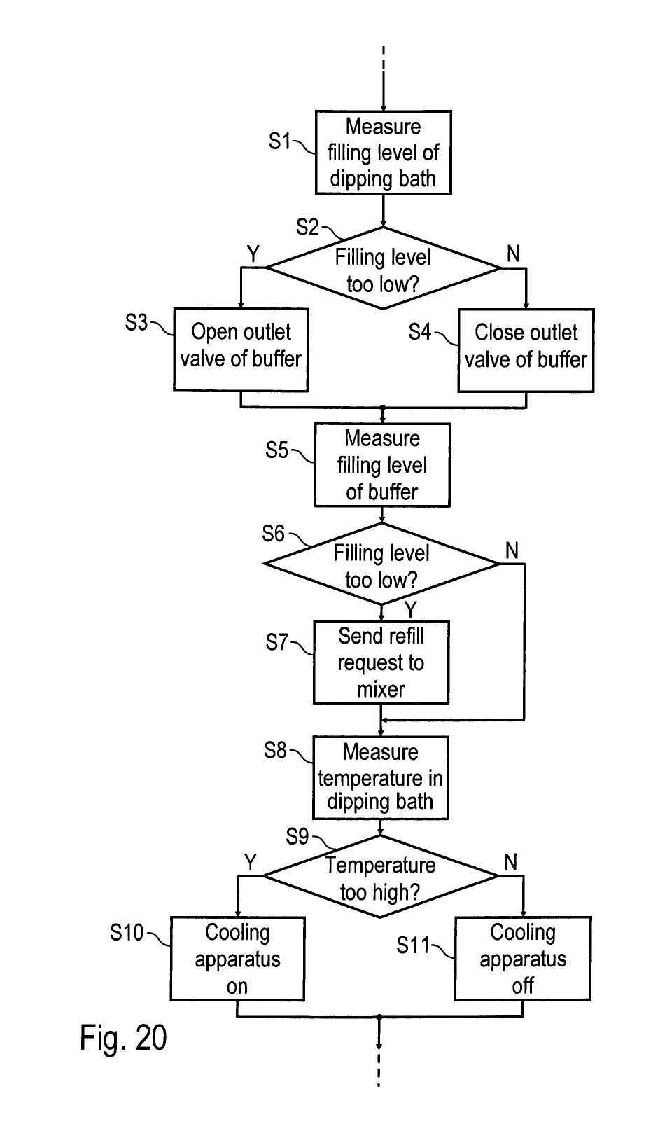

Moreover, the output conveyor 26 comprises an output end with an adjustable configuration. FIG. 7 shows a sharp nose configuration of the output end of the output conveyor 26, while FIG. 8 shows a butt nose configuration of the output end of the output conveyor 26. This is achieved by providing a lower roller 37 and an upper roller 38 at the output end of the output conveyor 26. The position of the upper roller 38 is fixed, while the position of the lower roller 37 can be changed in order to switch between the sharp nose configuration and the butt nose configuration. To adjust the sharp nose configuration as shown in FIG. 7, the lower roller 37 is pushed forward in a downstream direction as shown in FIG. 7. On the contrary, the lower roller 37 is retracted in an upstream direction in order to achieve the butt nose configuration as shown in FIG. 8.

### Buffer Arrangement

Further, the food processing machine according to the invention comprises the buffer arrangement 8 for buffering the batter between an external source (e.g. a mixer) and the dipping bath 7. This allows a continuous operation of the dipping bath 7 which can be refilled from the buffer arrangement.

The buffer arrangement 8 comprises a buffer tank 39 for receiving the batter from the external source (e.g. a mixer). The buffer tank 39 comprises a cleaning hatch 40 which is closed during operation and which can be opened manually for maintenance and cleaning purposes.

On its input side, the buffer tank 39 comprises an inlet 41 for introducing the batter into the buffer tank 39.

On its output side, the buffer tank 39 comprises several outlets 42, 43, 44, 45 for discharging the batter from the buffer tank 39. The outlets 42-45 can be opened or closed by integrated valves which can be actuated by a pressure cylinder 46 via a piston rod 47 and valve levers 48-51 associated to the individual outlets 42-45.

Further, the buffer arrangement 8 comprises a lower filling level sensor 52 and an upper filling level sensor 53. The lower filling level sensor responds when a filling level 54 of the batter in the buffer tank 39 exceeds a predetermined minimum filling level. The upper filling level sensor 53 responds if the filling level 54 of the batter in the buffer tank 39 exceeds a predetermined maximum filling level. Therefore, the filling level 54 of the batter in the buffer tank 39 will be maintained between the maximum filling level and the minimum filling level which will be explained in more detail later.

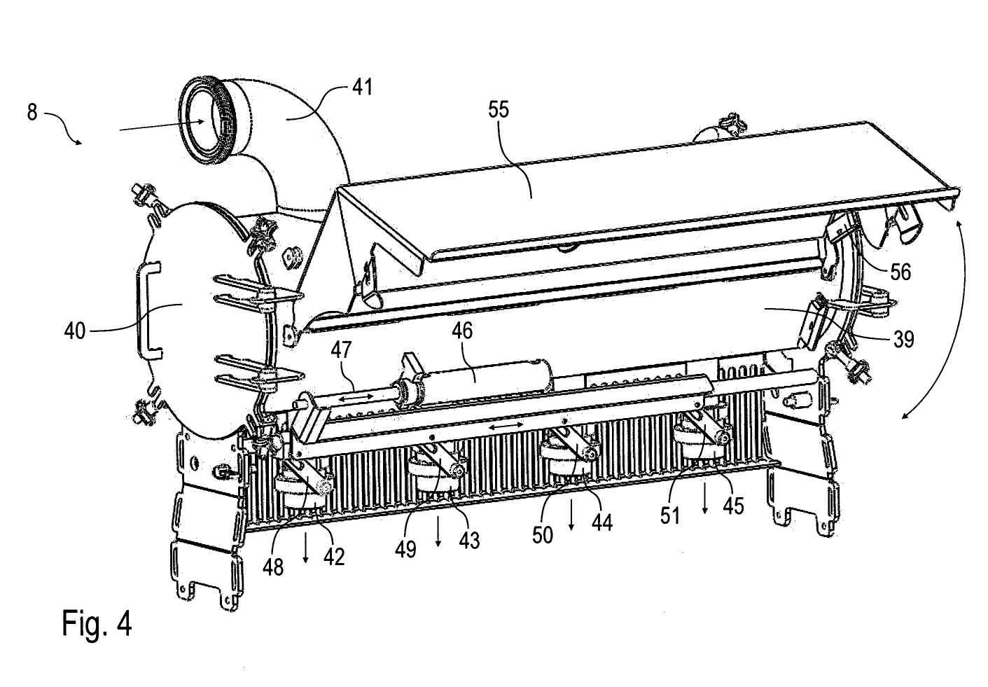

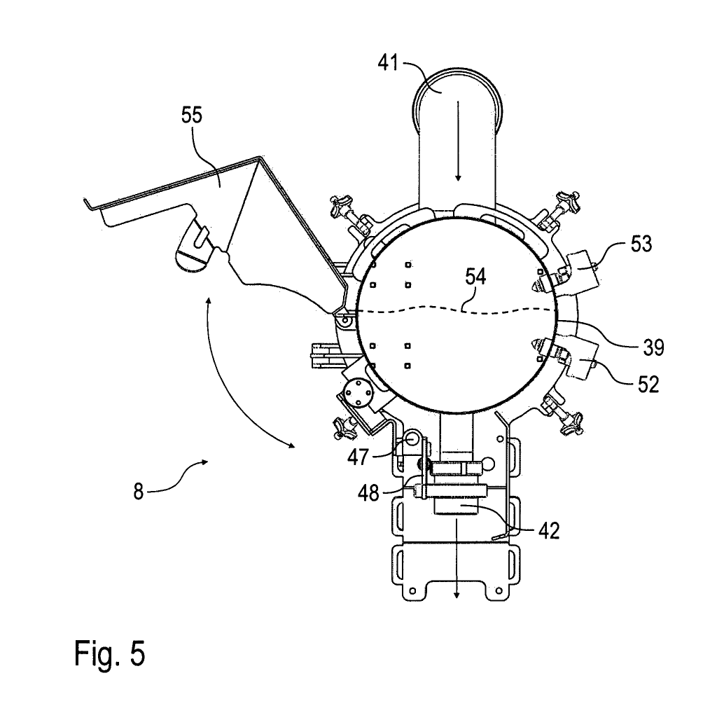

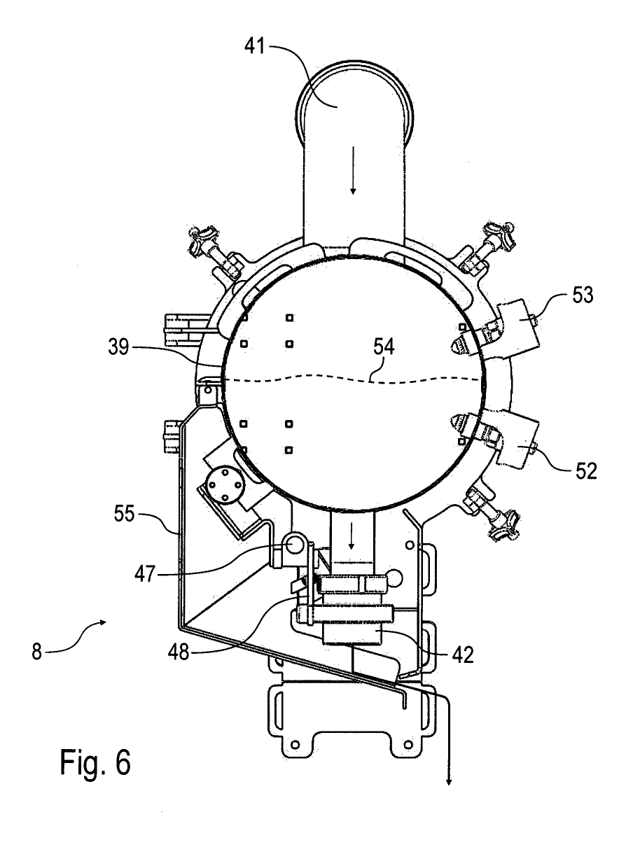

Moreover, the buffer arrangement 8 comprises a safety hatch 55, which can be swiveled between a closed operating position as shown in FIG. 6 and an opened maintenance position as shown in FIGS. 4 and 5. The position of the safety hatch 55 can be detected by a position sensor 56.

### Air Knife Arrangement

Further, the food processing machine comprises an air knife arrangement which is used to blow off excess product. The air knife arrangement is arranged downstream the dipping conveyor 24 so that the air jets blown out from the air knife arrangement 9 blow off excess batter from the coated products.

The air knife arrangement 9 comprises an upper front air knife 57, an upper rear air knife 58, a lower front air knife 59 and a lower rear air knife 60. In other words, there are two air knives 57, 58 above the product line and two air knives 59, 60 below the product line. The air flow necessary for the operation of the air knives 57-60 is generated by two blowers 61, 62 which are attached to the support frame 1 below the conveyor arrangement 6. The blowers 61, 62 are connected to the air knives 57-60 via air hoses 63-66.

### Control System

The control system 10 comprises an electrical cabinet 67, a control panel 68 and an emergency stop 69.

### Method of Operation

In the following, the method of operation of the food processing machine is explained with reference to the drawings.

During operation, uncoated food products (e.g. seafood, vegetables) are delivered in the direction of the arrows via the input conveyor 22 and the transfer conveyor 23 to the dipping conveyor 24. The dipping conveyor 24 conveys the uncoated food products through the dipping bath 7 so that the food products are coated with the batter within the dipping bath 7. Then, the dipping conveyor 24 removes the food products from the dipping bath 7 and transfers the coated food products to the transfer conveyor 25. Then, the air knife arrangement 9 blows off excess batter from the coated food products. Finally, the coated food products are discharged by the output conveyor 26.

The electrical cabinet 67 measures the filling level of the batter in the dipping bath 7 by polling the minimum filling level sensor 14 and the maximum filling level sensor 13.

If the filling level of the batter in the dipping bath 7 falls below the predetermined minimum filling level 12, the electrical cabinet 67 actuates the pressure cylinder 46 of the buffer arrangement 8 so that the outlet valves of the buffer arrangement 8 are opened. As a result, batter is discharged from the buffer tank 39 into the dipping bath 7 until the filling level of the batter in the dipping bath 7 exceeds the predetermined minimum filling level 12.

However, if the filling level of the batter in the dipping bath 7 exceeds the predetermined minimum filling level 12 or even the maximum filling level 11, the electrical cabinet 67 actuates the pressure cylinder 46 of the buffer arrangement 8 so that the outlet valves of the buffer arrangement 8 are closed. As a result, no further batter is discharged from the buffer arrangement 8 into the dipping bath 7.

Further, the electrical cabinet 67 also polls the lower filling level sensor 52 and the upper filling level sensor 53 of the buffer arrangement 8. If the filling level 54 of the batter in the buffer tank 39 falls below the predetermined lower filling level sensor 52, a refill signal is sent to the external source so that the buffer tank 39 is refilled.

Further, the electrical cabinet 67 also polls the temperature sensor 17 of the dipping bath 7. If the measured temperature exceeds a predetermined threshold, the electrical cabinet 67 activates the upper cooling labyrinth 18 and the lower cooling labyrinth 19 so that the temperature is reduced.

Although the invention has been described with reference to the particular arrangement of parts, features and the like, these are not intended to exhaust all possible arrangements of features, and indeed many other modifications and variations will be ascertainable to those of skill in the art. Particularly, the invention also claims protection for the subject-matter and the features of the independent claims independent from the referenced claims. Further, the invention comprises several aspects (e.g. buffer arrangement, air knife arrangement, control system and control method, configuration of the conveyor arrangement, etc.) which are independent from each other and constitute patentable subject-matter.

### LIST OF REFERENCE SIGNS:

h Height of product channel
1 Support frame
2 Roll
3 Roll
4 Roll
5 Roll
6 Conveyor arrangement
7 Dipping bath
8 Buffer arrangement
9 Air knife arrangement
10 Control system
11 Maximum filling level in the dipping bath
12 Minimum filling level in the dipping bath
13 Maximum filling level sensor of the dipping bath
14 Minimum filling level sensor of the dipping bath
15 Drain opening of the dipping bath
16 Drain valve of the dipping bath
17 Temperature sensor of the dipping bath
18 Upper cooling labyrinth of the dipping bath
19 Lower cooling labyrinth of the dipping bath
20 Coolant outlet tube
21 Coolant inlet tube
22 Input conveyor
23 Transfer conveyor between input conveyor and dipping conveyor
24 Dipping conveyor
25 Transfer conveyor between dipping conveyor and output conveyor
26 Output conveyor
27 Upper dipping conveyor
28 Lower dipping conveyor
29 Adjustment lever
30 Adjustment lever
31 Upstream section of output conveyor
32 Downstream section of output conveyor
33 Swivel axis
34 Guidance attached to upstream section
35 Guidance attached to downstream section
36 Guiding rod
37 Lower roller of output end of output conveyor
38 Upper roller of output end of output conveyor
39 Buffer tank
40 Cleaning hatch of buffer
41 Inlet of buffer
42 Outlet of buffer
43 Outlet of buffer
44 Outlet of buffer
45 Outlet of buffer
46 Pressure cylinder
47 Piston rod
48 Valve lever
49 Valve lever
50 Valve lever
51 Valve lever
52 Lower filling level sensor
53 Upper filling level sensor
54 Filling level of batter in the buffer tank
55 Safety hatch of buffer
56 Position sensor of safety hatch
57 Upper front air knife
58 Upper rear air knife
59 Lower front air knife
60 Lower rear air knife
61 Blower
62 Blower
63 Air hose
64 Air hose
65 Air hose
66 Air hose
67 Electrical cabinet
68 Control panel
69 Emergency stop

1-18. (canceled)

19. A food processing machine configured to process food products, the food processing machine comprising:
a dipping bath configured to contain a liquid or semi-liquid food material; and
a conveyor arrangement for conveying the food products through the dipping bath to coat the food products with the food material in the dipping bath, wherein the conveyor arrangement is a round belt conveyor.

20. The food processing machine according to claim 19, wherein the conveyor arrangement includes:
an input conveyor for receiving food products prior to coating, wherein the input conveyor an adjustable inclination;
a first transfer conveyor that receives the food products prior to coating from the input conveyor;
a dipping conveyor arranged downstream of the input conveyor, wherein the dipping conveyor conveys the food products through the dipping bath;
a second transfer conveyor that receives the food products coated with food material from the dipping conveyor; and
an output conveyor for outputting the food products coated with the food material, wherein the output conveyor has an adjustable inclination.

21. The food processing machine according to claim 20, wherein:
at least one of the input conveyor, the output conveyor, the first transfer conveyor, and the second transfer conveyor are wire belt conveyors; and
the dipping conveyor is a round belt conveyor.

22. Ne The food processing machine according to claim 20, wherein:
the output conveyor includes an adjustable output end that can be adjusted between a sharp nose position and a butt nose position; and
the output conveyor includes an upper roller and a lower roller at the output end of the output conveyor, wherein the lower roller can be shifted in a conveying direction in order o adjust either the butt nose position or the sharp nose position of the output end of the output conveyor.

23. The food processing machine according to claim 20, wherein:
the dipping conveyor includes an upper dipping conveyor and a lower dipping conveyor, wherein the upper dipping conveyor is movable between a lowered operating position and a raised maintenance position;
the upper dipping conveyor and the lower dipping conveyor together form a product channel in between, and the product channel runs through the dipping bath so that a complete cross section of the product channel is completely under a filling level in the dipping bath at least at one point of the product channel; and
the product channel has an adjustable height.

24. The food processing machine according to claim 23, further comprising a cooling apparatus for cooling at least one of the upper dipping conveyor and the lower dipping conveyor.

25. The food processing machine according to claim 24, wherein the cooling apparatus cools both the upper dipping conveyor and the lower dipping conveyor, and wherein the cooling apparatus includes:
an upper cooling labyrinth for cooling the upper dipping conveyor in the dipping bath; and
a lower cooling labyrinth for cooling the lower dipping conveyor, wherein the lower cooling labyrinth is arranged under the dipping bath.

26. The food processing machine according to claim 19, further comprising a buffer for buffering the food material, wherein the buffer includes an inlet for receiving the food material from an external source and an outlet for discharging the food material into the dipping bath, wherein the buffer is arranged above the conveyor arrangement and the outlet of the buffer includes a plurality of outlet openings arranged across the conveyor arrangement, wherein an outlet valve jointly opens or closes the outlet openings of the buffer.

27. The food processing machine according to claim 26, wherein the buffer includes:
a cleaning hatch that can be opened for cleaning an interior of the buffer;
a safety hatch movable between an opened maintenance position and a dosed operating position; and
a sensor detecting a position of the safety hatch, wherein the food material leaving the outlet openings of the buffer impinges an inside of the safety hatch with the safety hatch in the closed operating position.

28. The food processing machine according to claim 26, wherein the buffer includes a filling level sensor for measuring a filling level of the food material in the buffer, and wherein the outlet valve controls a flow of the food material from the buffer into the dipping bath.

29. The food processing machine according to claim 28, wherein the filling level sensor is a first filling level sensor, the food processing machine further comprising:
a temperature sensor configured to measure a temperature of the food material in the dipping bath;
a second filling level sensor for measuring a filling level of the food material in the dipping bath;
a drain outlet in the dipping bath and a drain valve arranged in the drain outlet; and
a control unit for controlling operation of the food processing machine.

30. The food processing machine according to claim 29, wherein an input side of the control unit is connected to at least one of the first filling sensor of the buffer and to the second filling level sensor of the dipping bath, and wherein an output side of the control unit is connected to the outlet valve of the buffer so that the control unit controls the filling level of the food material in the dipping bath.

31. The food processing machine according to claim 29, wherein an input side of the control unit is connected to the temperature sensor of the dipping bath and an output side of the control unit is connected to a cooling apparatus so that the control unit controls the temperature of the food material.

32. The food processing machine according to claim 19, further comprising at least one air knife to blow off excess food material after coating the food products, wherein the air knife is arranged downstream of the dipping bath.

33. The food processing machine according to claim 19, further comprising two air knifes above the conveyor arrangement and two air knifes below the conveyor arrangement.

34. The food processing machine according to claim 33, wherein the two air knifes above the conveyor arrangement and the two air knifes below the conveyor arrangement are all downstream of the dipping bath.

35. A method of operating a food processing machine, wherein the method comprises:
filling a dipping bath with a liquid or semi-liquid food material from an external source;
dipping food products into the food material in the dipping bath with a round belt conveyor to coat the food products with the food material; and
removing the food products from the dipping bath after dipping.

36. The method according to claim 35, further comprising buffering the food material in a buffer between the external source and the dipping bath.

37. The method according to claim 36, wherein
refilling the dipping bath with the food material from the buffer;
continuing to dip the food products in the food material in the dipping bath while refilling the dipping bath;
refilling the buffer with the food material from the external source; and
continuing to dip the food products in the food material in the dipping bath while refilling the buffer.

38. The method according to claim 36, further comprising:
measuring a filling level of the food material in the dipping bath; and
controlling a flow of the food material from the buffer into the dipping bath depending on the measured filling level in the dipping bath.

39. The method according to claim 36, further comprising:
measuring a filling level of the food material in the buffer; and
controlling a flow of the food material from the external source into the buffer depending on the measured filling level in the buffer.

40. The method according to claim 35, further comprising:
measuring a temperature in the dipping bath; and
controlling a cooling apparatus depending on the measured temperature.
